(19) United States
(12) Patent Application Publication
(10) Pub. No.: US 2004/0039781 A1
(43) Pub. Date: Feb. 26, 2004

(54) Peer-to-peer content sharing method and system

(76) Inventors: David Anthony LaVallee, Mercer Island, WA (US); Nicolas Hanauer, Seattle, WA (US)

Correspondence Address: PERKINS COIE LLP, PATENT-SEA, P.O. BOX 1247, SEATTLE, WA, 98111-1247, US

(21) Appl. No.: 10/222,214

(22) Filed: Aug. 16, 2002

(51) Int. Cl. G06F 15/16

(52) U.S. Cl. 709/205

(57) ABSTRACT

A method and system for sharing content among client computer systems. A content sharing system includes a server component executing on a server computer system that controls the logging on and off of users and establishes a connection or session with each client computer system whose user is logged-on. Because of these connections, administrative messages from one client to any other client can be sent via the server. The shared content, however, may be sent from client to client on a peer-to-peer basis without sending the shared content to the server.

### TECHNICAL FIELD

The described technology relates to computer systems that share content.

### BACKGROUND

Computer systems share files using a wide variety of file sharing techniques, including distributed file systems, replicated file systems, central file systems, etc. In addition, several special-purpose techniques have been developed to accommodate file sharing via the Internet. For example, a centrally indexed exchange allows providers of files to publish via a central computer system a list of files that are available to be shared. Users can browse the list provided by the central computer system to select a file and request a copy be sent to their own computer system. The central computer system then provides information so that the provider's computer system can transfer the selected file directly to the requestor's computer system without having the file pass through the central computer system.

A distributed indexed exchange is another example of a special-purpose technique for sharing files via the Internet. Unlike a centrally indexed exchange, a distributed indexed exchange does not store the list of available files at a central computer system. Rather, each computer system in the exchange provides a list of available files. To locate a file, messages are sent from computer system to computer system until a computer system that contains a desired file is located or a timeout occurs. Once the desired file is located, the provider computer system and the requestor computer system coordinate transfer of the file.

These techniques for sharing files have characteristics that prevent them from being effectively used in certain situations. In particular, when a group of users want to share their files within the group, these techniques often do not allow efficient and user-friendly sharing. For example, since users do not usually store a local duplicate copy of a file that is stored by a central file system, each time a user wants to access a shared file, the contents of the file need to be transferred from the central file system to the user's computer system. Depending on the configuration of the communications link between the user's computer system and the central file system, the transfer of the file may take a relatively long time. As another example, a centrally indexed exchange has the disadvantage that users of the group would need to manually locate the files for the group using a central index, and then download each file as appropriate. As another example, some web sites allow users to publish content such as pictures that are stored centrally. The publisher, however, typically needs to notify others (e.g., via email) that new content is available. Also, the users accessing the published content would need to wait while content is downloaded. As discussed above, this can take a relatively long time. Another disadvantage is that when a group of users wants to share content, each user in the group would need to have their own account on the web site, and each user would need to remember the access information for each other member in the group. It would be desirable to have a file sharing system that would simplify the process of sharing files among groups of users.

### BRIEF DESCRIPTION OF THE DRAWINGS

FIG. 1 is block diagram illustrating components of the content sharing system in one embodiment.

FIG. 2 is a flow diagram of the processing performed when a user logs on to the content sharing system.

FIG. 3 is a flow diagram illustrating the processing of the server when it receives a message in one embodiment.

FIG. 4 is a flow diagram illustrating the process of a user sending an invitation message to another user in one embodiment.

FIG. 5 is a flow diagram illustrating the processing performed when a client receives an invitation message.

FIG. 6 is a flow diagram illustrating the processing of a client when an invitation is accepted by the logged-on user.

FIG. 7 is a flow diagram illustrating the processing of a client when it receives an RSVP message.

FIG. 8 is a flow diagram illustrating the process of electing a master in one embodiment.

FIG. 9 is a flow diagram illustrating the process of a client synchronizing with a master.

FIG. 10 is a flow diagram illustrating processing of the master when a synchronization message is received from a client.

FIG. 11 is a flow diagram illustrating processing of a master that receives content from a client.

FIG. 12 is a block diagram illustrating the processing of a client that receives a logon message.

FIG. 13 is a flow diagram illustrating the processing of a client that receives a logoff message.

FIG. 14 illustrates multiple local masters in one embodiment.

FIG. 15 illustrates the election of a global master in one embodiment.

FIG. 16 is a block diagram illustrating the discovery of whether a client is open or closed.

FIG. 17 is a block diagram illustrating the discovery of whether a client is closed because its communications are part forwarded.

### DETAILED DESCRIPTION

A method and system for sharing content among client computer systems is provided. In one embodiment, a content sharing system includes a server component executing on a server computer system (“server”) that controls the logging on and off of users and establishes a connection or session with each client computer system (“client”) whose user is logged-on. Because of these connections, administrative messages from one client to any other client can be sent via the server. The shared content, however, may be sent from client to client on a peer-to-peer basis without sending the shared content to the server.

In one embodiment, each client has a client component that participates in the election of a master client computer system (“master”) that then coordinates the peer-to-peer transfer of content. The master can communicate on a peer-to-peer basis with the client of each logged-on user. A provider client shares content with other clients by informing the master, which then sends a message via the server to the other clients indicating that the content is to be shared. The message may also include information indicating which client is to provide the content being shared. The provider client may then transfer the shared content to the master on a peer-to-peer basis. Depending on the information provided in the message, other clients can request the master to send the shared content to them on a peer-to-peer basis.

In one embodiment, content is organized into folders so that each folder can be shared among a group of specified users, referred to as members of the group. All members of a group of which a user is also a member are referred to as “co-members” of that user. The creator of a folder, also referred to as the owner of the folder, invites other users to become members of a group that has access to the contents of the folder. An owner invites a user to join a group by sending an invitation message to the user (i.e., the invitee) via the server. The invitee can either accept or decline the invitation. When accepted, the invitee becomes a member of the group and participates in the sharing of the content of the shared folder. A notice of invitation message and the corresponding RSVP message is sent to all members and invitees of the group. In this way, each member and invitee can track the membership of the group.

The users who are registered with the content sharing system can log on and off the content sharing system to participate in the sharing of content. The server controls the logon and logoff process and authenticates each user as the user logs on. The client of one logged-on member of each group may be designated as a global master for that group. A global master is “open” in the sense that it can receive messages directly from any client of the other logged-on members of the group on a peer-to-peer basis. In one embodiment, a computer system is open when it implements an HTTP server and can receive HTTP request messages from any computer system. A computer system may be “closed” when a firewall prevents it from receiving HTTP request messages. When a member adds content to a folder, the member's client notifies the master that new content is available. The master can then direct the member's client to send that content to the master using a peer-to-peer connection. The master can then send a message via the server to the clients of all other members to notify them that new content has been added to the folder. The clients of other members can then retrieve a copy of the new content from the master or other designated client of a logged-on member that is open. In this way, the client of each member that is logged-on obtains a local copy of the contents of the folder.

When a member logs on to the content sharing system, the member's client synchronizes its local content of the folder with the content of the master's folder. Synchronization is needed because, for example, other members may have added new content to the folder while the member was logged off or because the logging-on member may have added content to their local folder while logged off. The client may request (e.g., via a peer-to-peer connection) from the master a list of the master's content. The master's folder should accurately reflect the content of the folder as known to the clients of currently logged-on members. The request and response list may be provided via an HTTP get request and response message pair. The client can then identify any differences between its local content and the master's content. The differences may include content that the client has but the master does not have, and vice versa. The client then notifies the master of those differences (e.g., via an HTTP put request message). When the client has content that the master does not, the master notifies the client to send the content to the master (e.g., via an HTTP response message). The client can then send the content directly to the master (e.g., via an HTTP put request message). The master then notifies, via a message distributed by the server, the clients of the other members that the new content is available to be downloaded from the master. When the master has content that the client does not, the master directs the client to request the content from the master. In this way, the client of each logged-on member stays synchronized with the clients of other logged-on members, and as members log on, their clients become synchronized with the clients of other logged-on members. This synchronization is repeated for each folder of which the logging-on user is a member.

In one embodiment, the clients of logged-on members of a folder each use a predefined algorithm in a distributed manner to determine which member's client is to be the master. A member's client is qualified to be a master as long as the member is logged-on and the member's client is open. In one embodiment, the algorithm may select a qualified client whose member has been logged-on the longest as the master. When a member logs on, the server sends a message to the clients of all other logged-on members. The message includes the logon time of that member. The message may also include an indication of whether the member's client is open or closed, the external and internal IP address of the client, and a session identifier as described below in more detail. This information is referred to as “presence information” since it is provided to clients when a member logs on or an invitee accepts an invitation. In addition, the server sends to the logging-on client messages indicating the logon time of the other members who are currently logged-on. Thus, each client of a logged-on member knows the logon time of all members who are currently logged-on. The client of each logged-on member knows the qualified client whose member has been logged-on the longest. In another embodiment, the algorithm may select the master based on an alphabetical ordering of the names of the members. However, as a member logs on, that member may then be selected as master, resulting in the possibility of a new master being selected each time a new member logs on. Alternatively, the master may be selected in a centralized manner, for example, by the server, which sends messages to the clients of logged-on members informing them of the master.

In one embodiment, a client discovers whether it is open or closed based on another computer system's (e.g., the server's) success or failure in communicating with the client. The client sends a message, such as an HTTP get request message, to the server. Upon receiving the message, the server sends a message, such as an HTTP get request message, to the client. If the client provides an appropriate response, such as an HTTP response message, then the server knows that the client is open and sends a response message, such as an HTTP response message that is responsive to the previously received HTTP get request message, to the client indicating that the client is open. The response message may also include the external IP address that the server used to access the client. If, however, the server receives no appropriate response, then the server knows that the client is closed and sends a response message to the client indicating that the client is closed along with an indication of the client's external IP address. The server can provide to the client of a user that logs on an indication of the users currently logged-on, along with their open or closed statuses, external and internal IP addresses, and the session identifiers of their clients, as well as the logon times of the users. The server can also provide the client of each logged-on user with the same information for the user who logs on. This discovery technique may be used, for example, when a client is closed because it is located behind a firewall. This discovery technique can be used, more generally, between any two computer systems as long as at least one of the computer systems is open to the other computer system.

In one embodiment, a client discovers whether it is open or closed based on a session identifier (“SID”) that is used when communicating with the server. When a client establishes a communications session with the server, the session is assigned an SID by the server. If that client is located behind a router, then that client's communications are forwarded through the router. The router may be configured to forward all network requests to a single client behind the router. If so, that single client is open and all other clients behind the router are closed. To determine whether a client is open or closed, the client establishing a session with the server sends to the server a message that includes the client's SID and the IP address of the router. When the server receives the message, it sends a message to the client via the IP address. Upon receiving the message, the client compares the SID within the message to its own SID. If the SID are the same, then the client knows it is open, otherwise the server knows it is closed. The client notifies the server and the server responds with the IP address of the router.

In one embodiment, the communications between the master and the other clients may use communications protocols such as TCP/IP that perform significant error checking to ensure that packets of messages arrive at their destination in the appropriate order. Alternatively, the communications may use communications protocols such as UDP/IP that do not perform significant error checking, and may not ensure the delivery or the order of packets. In such a case, the clients may add sequencing information to the packets and send each packet twice to the destination client. When the destination client receives the packets, it can discard any duplicate packets that it receives, and it can order the packets sequentially according to the added sequencing information. If the destination client for some reason does not receive one of the packets, it can notify the sending client to resend the missing packets.

In one embodiment, the server of the content sharing system uses a publish-and-subscribe model to support communications between clients sent via the server. Each member or invitee of a group subscribes to receive messages published by other members or invitees. When a message is published, the server forwards the message to the client of each logged-on member or invitee of that group and effectively queues the messages for members and invitees who are not currently logged-on. When a member or invitee logs on, the server sends each of the queued messages to the client of that member or invitee. The client can then act on the message as appropriate. For example, the client may process RSVP messages to indicate whether the invitee has accepted or may discard new content messages because the content will be synchronized via the synchronization process with the master. In one embodiment, most messages relating to a folder are only sent to members of the group that share the folder, while invite and RSVP messages are sent to invitees of the group. As a result, when an invitee accepts an invitation, each member is notified of the new member's presence information, so that a master can be elected as appropriate, and each client of logged-on members will know of the clients of all other logged-on members.

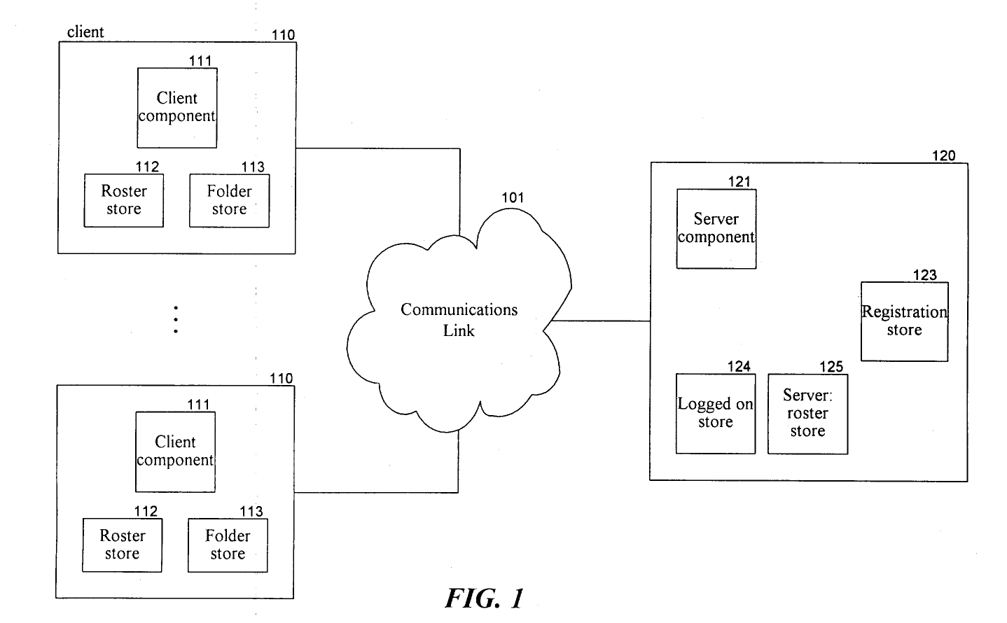

FIG. 1 is a block diagram illustrating components of a content sharing system in one embodiment. The content sharing system includes clients 110 and a server 120 that communicate via a communications link 101. The clients include a client component 111, a roster store 112, and a folder store 113. The roster store for a user contains the identification of registered users that are known to that member. The user's roster store may be updated each time the user's client receives a message (e.g., a logon message with presence information) from a user not previously known to that user. The folder store for a user contains the content of each folder of which the user is a member or invitee and a list of each folder's members and invitees. The server includes a server component 121, a registration store 123, a logged-on store 124, and a roster store 125. The registration store contains the identification of all users that are authorized to use the content sharing system, referred to as registered users. The logged-on store identifies those users that are currently logged on to the content sharing system. The roster store contains the roster for each registered user. When a user logs on, the server provides the roster to the user's client and may provide the name of each folder of which the user is a member or invitee. With this information, users can move from client to client (e.g., work computer to home computer) and still have access to their roster lists and the folders of which they are members.

The client computer systems and the server computer system may include a central processing unit, memory, input devices (e.g., keyboard and pointing devices), output devices (e.g., display devices), and storage devices (e.g., disk drives). The memory and storage devices are computer-readable media that may contain instructions that implement the client component and server component. In addition, the data structures and message structures may be stored or transmitted via a data transmission medium such as a signal on a communications link. Various communications links may be used, including the Internet, a local area network, a wide area network, or a point-to-point dial-up connection.

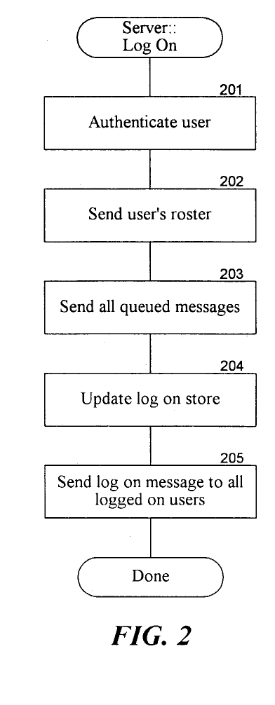

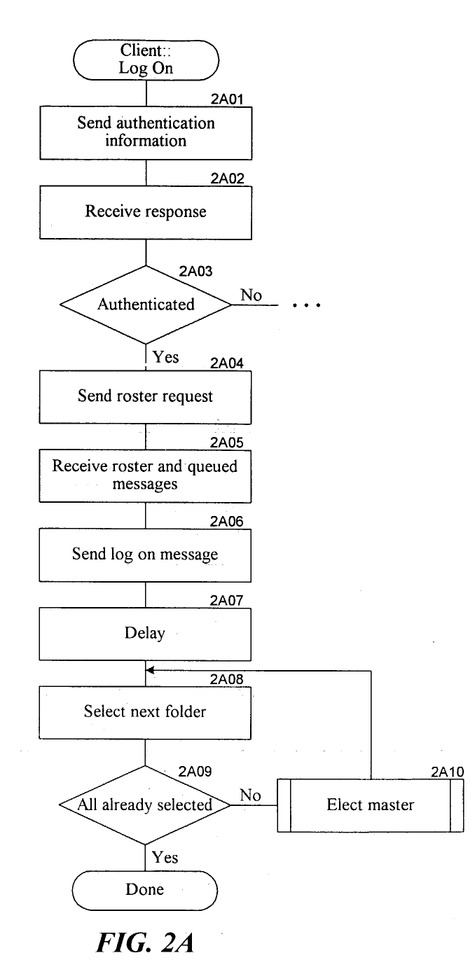

FIG. 2A is a flow diagram illustrating the processing of a client when a user logs on to the content sharing system. In block 2A01, the client's component sends an authentication request along with authentication information to the server. In block 2A02, the client component receives from the server a response to the authentication request. In decision block 2A03, if the response indicates that the user has been authenticated, then the component continues at block 2A04, else the component terminates, takes some action to re-authenticate the user, or takes some other appropriate action. In block 2A04, the component sends a request for the user's roster to the server. In block 2A05, the component receives the user's roster and any messages that were queued for the user while the user was logged off. In block 2A06, the component sends a logon message (also known as a presence message) that includes presence information to the clients of all other logged-on users to notify them that the user has logged-on. In block 2A07, the component waits to allow time for the client to receive logon messages indicating which other members of the groups of which the user is a member are currently logged-on. In an alternate embodiment, the server may send the presence information for the other members via a single message to avoid the need to delay. In blocks 2A08-2A10, the component loops, selecting the master for each folder of which the user is a member. In block 2A08, the component selects the next folder of which the user is a member. In decision block 2A09, if all the folders have already been selected, then the component completes, else the component selects the master for the selected folder in block 2A10 and then loops to block 2A08 to select the next folder.

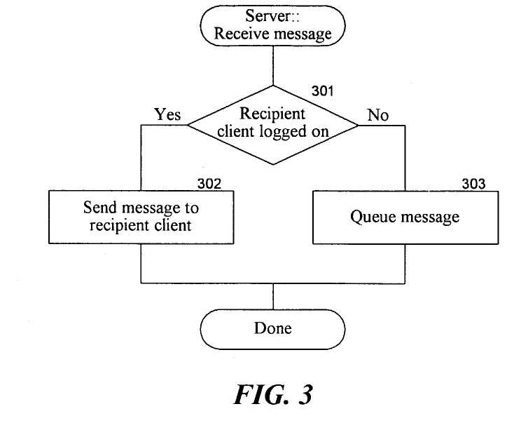

FIGS. 2 and 3 are flow diagrams illustrating processing of a server in one embodiment. FIG. 2 is a flow diagram of the processing performed when a user logs on to the content sharing system. The server authenticates the user, sends the roster to the user's client, and then sends the queued messages to the client. In one embodiment, the server may also identify the folders of which the user is a member or an invitee. In this way, if a user logs on using different clients, each client will know which folders to synchronize. The server also sends a log on message to the client of each logged-on co-member to indicate that another member has just logged-on. In block 201, the server component authenticates the user. Various authentication schemes may be used, including a user name and password mechanism, or a public and private key encryption mechanism. In block 202, the component sends to the client the roster of the user who has logged-on. In block 203, the component sends all the queued messages to the client. In block 204, the component updates its logged-on store to indicate that the user is now logged-on. In block 205, the component sends a logon message to the client of each logged-on co-member and sends one or more messages to the client of the logging-on user informing the client of all other co-members who are logged-on.

FIG. 3 is a flow diagram illustrating the processing of a server when it receives a message in one embodiment. In decision block 301, if the recipient user is currently logged-on as indicated by the logged-on store, then the server's component continues at block 302, else the component continues at block 303. In block 302, the component sends the message to the client of the recipient user and then completes. In block 303, the component queues the message for the recipient user. In one embodiment, the messages are distributed using a publish-and-subscribe model. Each user would subscribe to classes of messages that are appropriate to that user. For example, if a user is a member of a certain group, it would subscribe to messages related to that group. Alternatively, all users may subscribe to certain types of messages, such as a log on message.

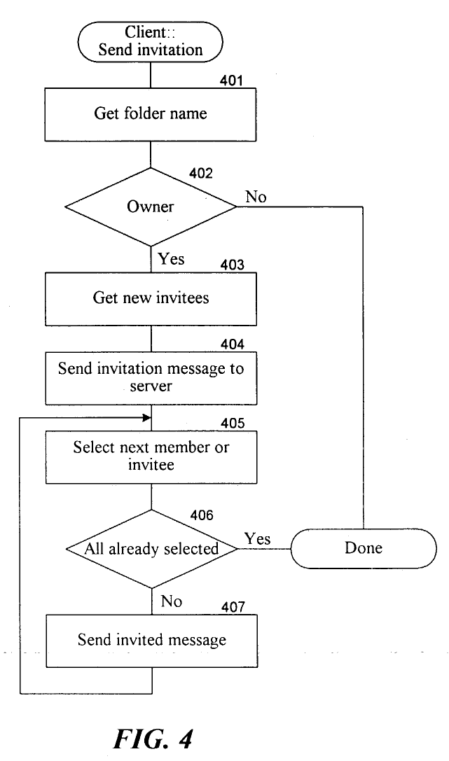

FIGS. 4-7 are flow diagrams illustrating the process of inviting a user to join a group for a folder. FIG. 4 is a flow diagram illustrating the process of a user sending an invitation message to another user in one embodiment. The owner may be the only member who can invite others to join a group. Alternatively, each member of a group may have privileges (e.g., an access control list) defined, specifying whether the member can invite others to join the group or can modify the content of the group's folder. In block 401, the client's component retrieves the identification of the folder. In decision block 402, if this member is the owner of the folder or otherwise has the privilege to invite users to join a group, then the component continues at block 403, else the component completes. In block 403, the component retrieves from the member the identification of the new invitee. The invitee may be selected from the member's roster. In block 404, the component sends an invitation message to the invitee via the server. The server forwards the message to the invitee if the invitee is currently logged-on, else the server queues the message until the invitee logs on. In blocks 405-407, the component loops, sending notifications of the invitation to each member and invitee of the group. Alternatively, this looping may be logically performed by the server using a publish-and-subscribe model. In block 405, the component selects the next member or invitee of the group. In decision block 406, if all members and all invitees have already been selected, then the component completes, else the component continues at block 407. In block 407, the component sends a notification of an invitation message to the selected member or invitee and then loops to block 405 to select the next member or invitee.

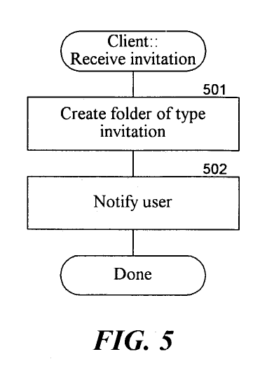

FIG. 5 is a flow diagram illustrating the processing performed when a client receives an invitation message. In one embodiment, the client automatically creates a folder for the logged-on user when an invitation message is received, but the folder has its folder type set to “invitee.” When the user accepts the invitation, the client changes the folder type to “member.” In one embodiment, the client displays an invitee folder just like it displays a member folder, except that the invitee folder has an invitation icon for accepting or declining the invitation and has no content associated with it. When the user declines an invitation, the client removes the folder. In block 501, the component creates a folder of type invitee. In block 502, the component notifies the user. The user may be notified by redisplaying the current list of folders. The user would then see the new folder of the type invitee. The component then completes.

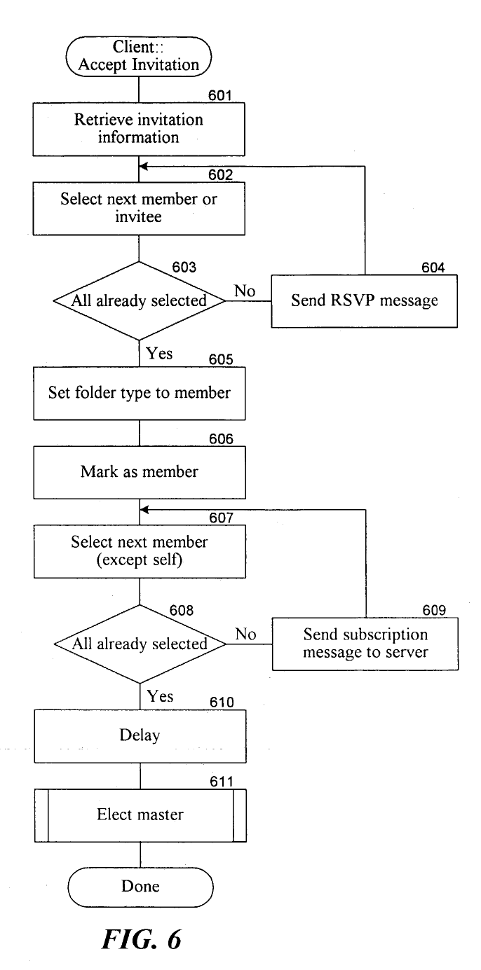

FIG. 6 is a flow diagram illustrating the processing of a client when an invitation is accepted by the logged-on user. A user may accept an invitation by selecting an accept icon associated with the folder. The component sends a notification of the acceptance to all other members and invitees, and subscribes to receive messages from all other members and invitees. In block 601, the component retrieves the information about the invitation. The client may have stored this information in association with the folder that was created when it received the invitation message. In blocks 602-604, the component loops, sending an RSVP message to each member and invitee. Alternatively, if each member and invitee has subscribed to the messages of other members and invitees, then the client need only publish the RSVP message and the server will send the message to each subscriber. In block 605, the component sets the folder type to member. In block 606, the component marks the user as a member of the group. In blocks 607-609, the component loops, sending a subscription message to the server for each member of the group. In block 607, the component selects the next member of the group. In decision block 608, if all the members have already been selected, then the component continues at block 610, else the component continues at block 609. In block 609, the component sends a subscription message to the server and then loops to block 607 to select the next member. In block 610, the component delays. This delay allows the client of the new member to receive the logon messages with presence information from all other members of the group who are logged-on before selecting a master. In block 611, the component elects a master and then completes.

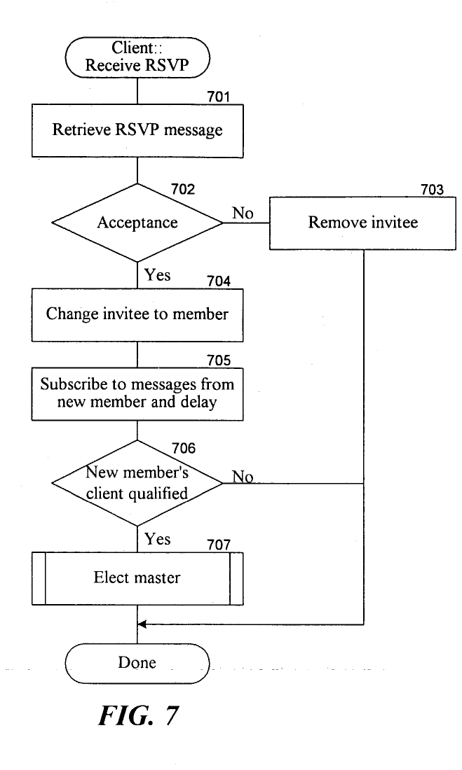

FIG. 7 is a flow diagram illustrating the processing of a client when it receives an RSVP message. The client records the invitee as having accepted or declined and elects a new master as appropriate In block 701, the component retrieves the RSVP message. In decision block 702, if the RSVP message indicates that the invitation has been accepted, then the component continues at block 704, else the component continues at block 703. In block 703, the component removes the invitee from the list of invitees and then completes. In block 704, the component changes the invitee to be a member of the group. In block 705, the component subscribes to receive messages of the new member and delays to allow time to receive the presence information for the new member. In decision block 706, if the client of the new member is qualified to be a master, then the component continues at block 707, else the component completes. In block 707, the component elects a master and then completes.

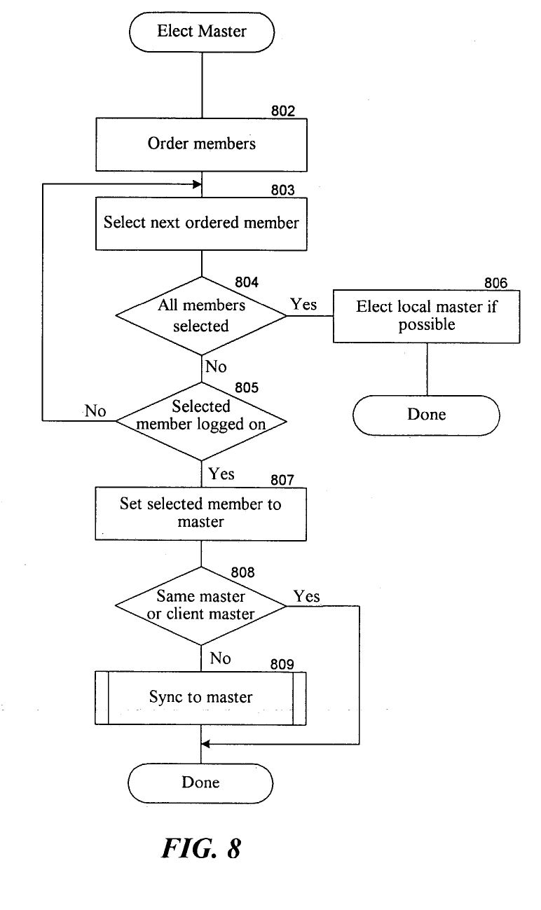

FIG. 8 is a flow diagram illustrating the process of electing a master in one embodiment. Each client with a logged-on member of a group elects a master for that group. Since all the clients use the same algorithm, they elect the same master, except in the event a local master is elected. In block 802, the component orders the members in a predefined order (e.g., based on logon time). In blocks 803-805, the component loops, identifying the client of the first member in the ordered list that is qualified to be a master. In block 803, the component selects the next ordered member. In decision block 804, if all the members have already been selected, then the component continues at block 806, else the component continues at block 805. In decision block 805, if the client of the selected member is qualified, then the component continues at block 807, else the component loops to block 803 to select the next ordered member. In block 806, the component elects a local master, if possible, and then completes. When a user logs on, the server may provide the user's client with a domain name of the network to which the client is connected. The client can then participate in the selection of a local master for the clients within that domain name. In block 807, the component designates the client of the selected member as the master. In decision block 808, if this client is the master or the master is the same master that this client previously selected, then there is no need to synchronize and the component completes, else the component continues at block 809. In block 809, the component synchronizes with the selected master and then completes.

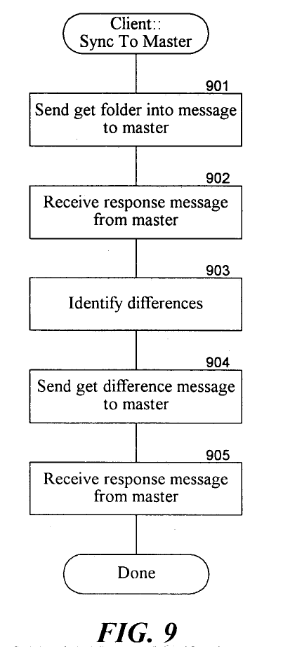

FIG. 9 is a flow diagram illustrating the process of a client synchronizing with a master. In block 901, the component sends to the master an HTTP get request message that requests a list of the contents of the master's folder. In block 902, the component receives the HTTP response message from the master. In block 903, the component identifies differences between the content of the master's folder and the content of the client's folder. For example, if the client's user has just logged-on, then the client's folder may have additional content of which the master is not aware, and vice versa. In block 904, the component sends an HTTP get request message to the master indicating the differences and then completes. In block 905, the component receives from the master an HTTP response message indicating how the client is to reconcile the differences.

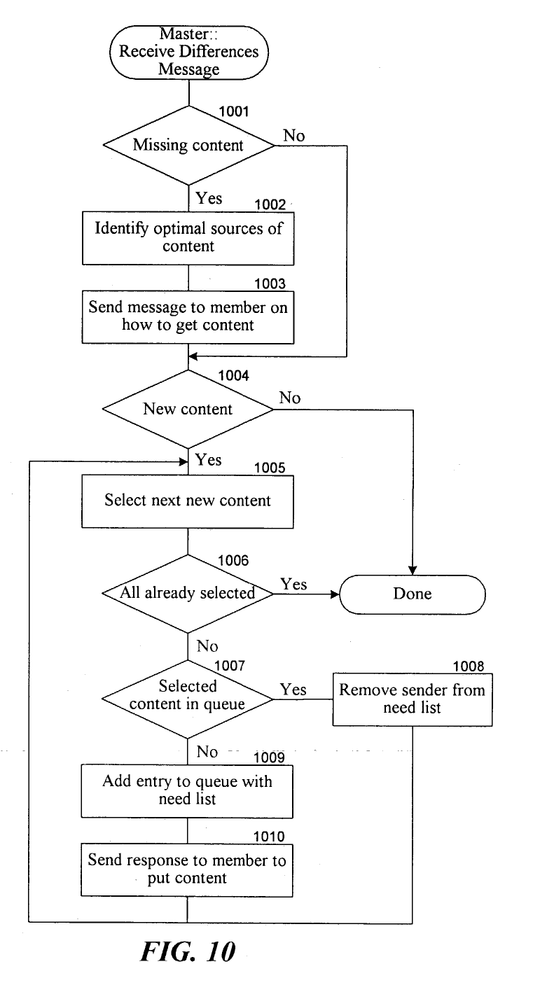

FIG. 10 is a flow diagram illustrating processing of the master when a synchronization message is received from a client. The component determines whether the client is missing content or has additional content to add to the folder. In decision block 1001, if the client is missing content, then the component continues at block 1002, else the component continues at block 1004. In block 1002, the component identifies the optimal sources for providing the content to the client. In one embodiment, the component may direct the client to retrieve the missing content from the master. Alternatively, the component may direct the client to retrieve content from another client that has the content and is open to the client. The component may also direct the client to retrieve portions of the missing content from different clients that have the content. Although not illustrated, the component performs-the same processing for each missing content. In block 1003, the component sends a message to each logged-on member informing them how to retrieve the new content. In decision block 1004, if the client has new content that the master does not have, then the component continues at block 1005 to retrieve that content, else the component completes. In blocks 1005-1010, the component loops, directing the client to provide the new content to the master. The master maintains a queue with an entry for each new content that is to be received from the client. Each entry of the queue has a need list indicating the other clients that need to have the new content provided to them. The master uses the need list to send messages to the clients of logged-on members with instructions on how to retrieve the new content. If the component detects that a client on the need list already has received a copy of the content, then it removes that client from the need list. In block 1005, the component selects the next new content that the master does not have. In decision block 1006, if all the content has already been selected, then the component completes, else the component continues at block 1007. In decision block 1007, if the selected content is in the queue, then the component continues at block 1008, else the component continues at block 1009. In block 1008, the component removes the sending client from the need list in the queue because the sending client already has that content. The component then loops to block 1005 to select the next new content. In block 1009, the component adds an entry to the queue with a need list that lists all the logged-on members. In block 1010, the component sends a response to the client directing the client to put the content to the master. The component then loops to block 1005 to select the next content.

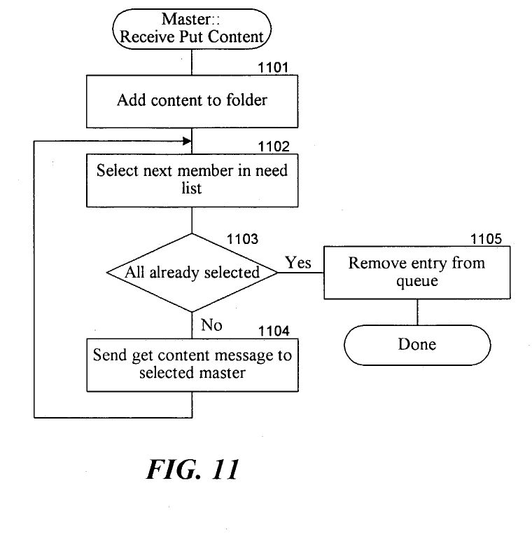

FIG. 11 is a flow diagram illustrating processing of a master that receives content from a client. In block 1101, the component adds the content to the folder. In blocks 1102-1104, the component loops, instructing the client of each member on the need list for that content how to retrieve the content. In block 1102, the component selects the next member of the need list for that content. In decision block 1103, if all the members on the need list have already been selected, then the component continues at block 1105, else the component completes. In block 1104, the component sends a get content message to the selected member via the server and then loops to block 1102 to select the next member. In block 1105, the component removes the entry from the queue for the content and then completes.

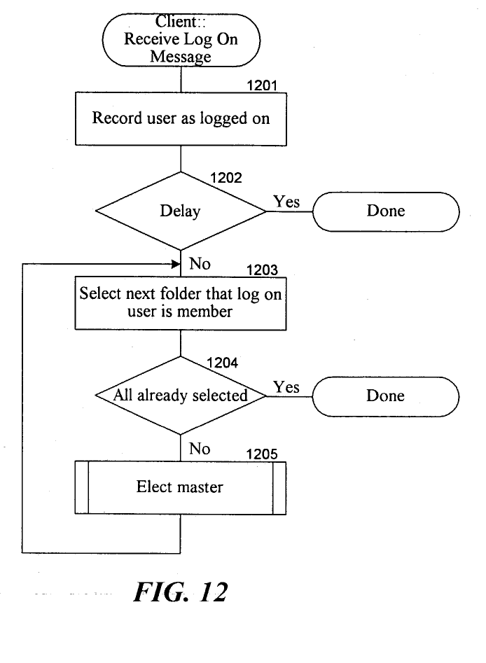

FIG. 12 is a block diagram illustrating the processing of a client that receives a logon message. The component identifies the folders of which the newly logged-on user is a member and performs the master election algorithm for that folder. If this client is delaying because its user just recently logged-on or an invitee has joined the group, then this component simply completes because the master election will be performed after the delay. In block 1201, the component records the user as being logged-on. In decision block 1202, if this client is delaying, then the component completes, else the component continues at block 1203. In block 1203, the component selects the next folder for which the newly logged-on user is a member. In decision block 1204, if all the folders have already been selected, then the component completes, else the component continues at block 1205. In block 1205, the component elects the new master and then loops to block 1203 to select the next folder.

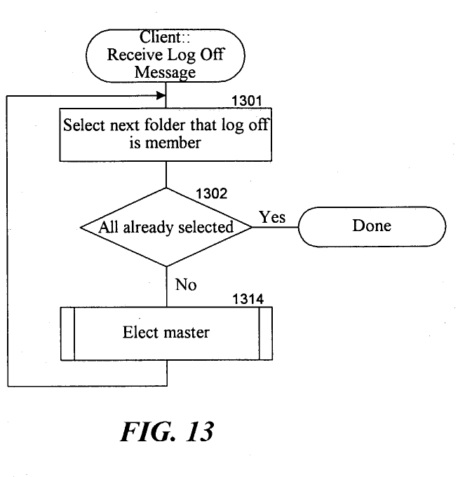

FIG. 13 is a flow diagram illustrating the processing of a client that receives a logoff message. The component identifies the folders of which the newly logged-off user is a member and performs the master election algorithm for that folder. In block 1301, the component selects the next folder of which the logged-off user is a member. In decision block 1302, if all the folders have already been selected, then the component completes, else the component continues at block 1303. In block 1303, the component elects a new master and then loops to block 1301 to select the next folder.

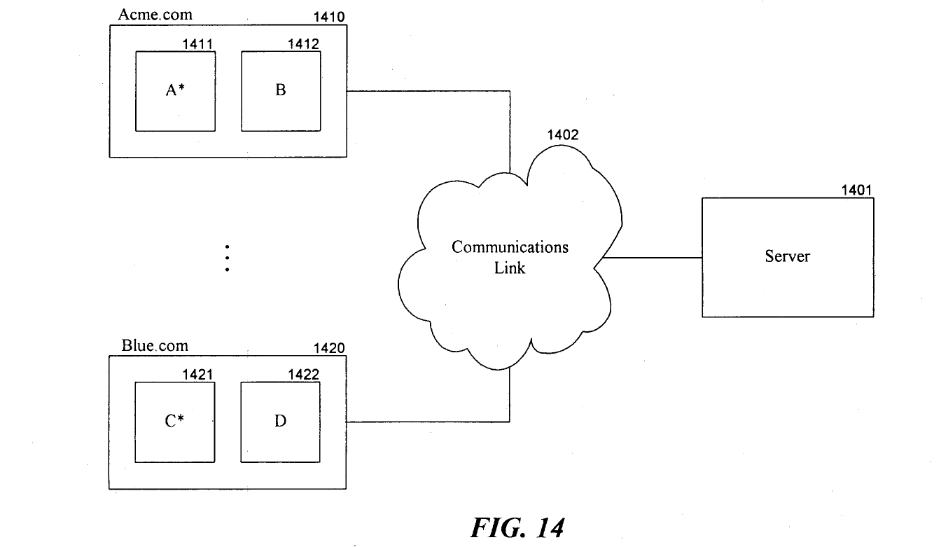

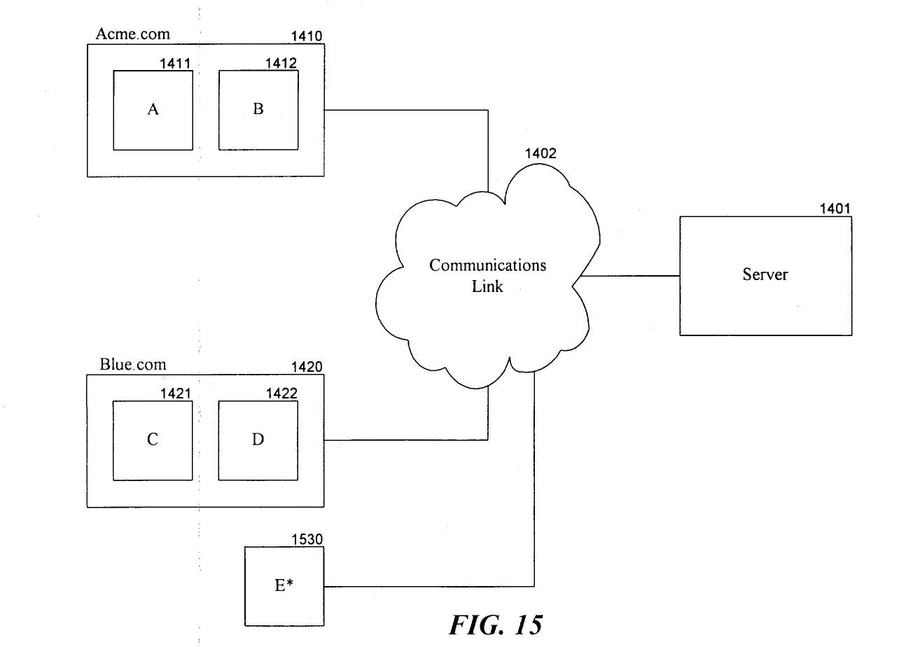

FIGS. 14-15 are block diagrams illustrating a local master and a global master. A global master for a folder is a qualified client, that is, its user is currently logged-on to the content sharing system and the client is open to the client of each member who is currently logged-on to the content sharing system. If no client is qualified, then clients of subgroups of members may elect a local master. A client is a locally qualified client if its user is currently logged on to the content sharing system and the client is open to all the clients of each member of the subgroup who is currently logged-on to the content sharing system. For example, clients behind a common firewall may not be open to clients outside the firewall, but they may be open to all clients inside the firewall. In such a case, the clients behind the firewall may elect one of the clients as a local master. The local master performs all the functions of a master as applied to the clients of members within the subgroup.

FIG. 14 illustrates multiple local masters in one embodiment. The server 1401 communicates with clients within the Acme.com domain 1410 and with clients within the Blue.com domain 1420 via a communications link 1402. The Acme.com domain includes clients 1411 and 1412, and the Blue.com domain includes clients 1421 and 1422. The clients with the asterisk are a local master. In this example, both domains have firewalls so that none of the clients within the domain are open to clients outside the firewall. The clients 1411 and 1412 share content with each other as if they are the only clients with members who are logged on to the folder.

FIG. 15 illustrates the election of a global master in one embodiment. When the user of client 1530 logs on to the content sharing system, all the clients of currently logged-on members receive the logon message and perform an election. In this case, client 1530 is open to clients 1411 and 1412, and to clients 1421 and 1422. Thus, each of the clients elects the client 1530 as the global master. The clients 1411 and 1412, and clients 1421 and 1422, then synchronize their content with the global master, client 1530.

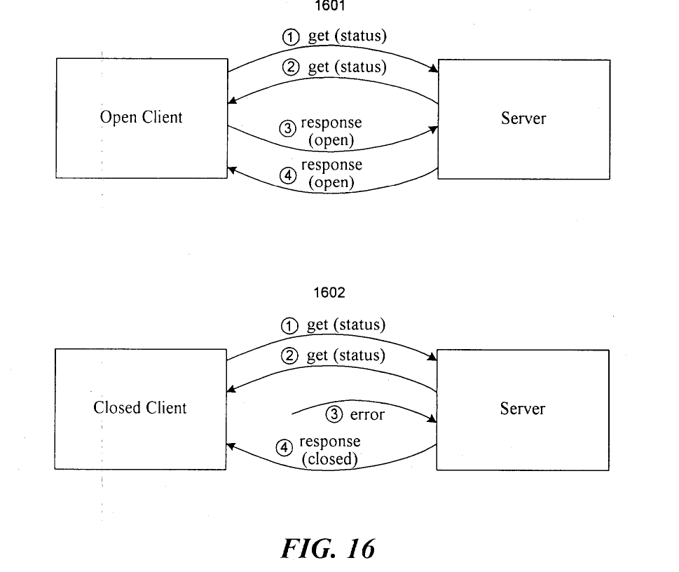

FIG. 16 is a block diagram illustrating the discovery of whether a client is open or closed. In 1601, a server detects that a client is open. The client initially sends to the server a request message (e.g., an HTTP get request) that requests the server to identify whether the client is open or closed. Upon receiving the message, the server sends to the client a request message. In this case, since the client is open, it sends a response message to the server. Upon receiving the message, the server detects that the client is open and sends a response message to the client indicating that the client is open. In 1602, the server detects that the client is closed. The client initially sends to the server a request message that requests the server to identify whether the client is open or closed. Upon receiving the message, the server sends to the client a request message. In this case, since the client is closed, no response or error message is sent to the server. In either case, the server detects that the client is closed and sends a response message to the client indicating that the client is closed. The server can include the open or closed status in the logon message it sends to the clients of all logged-on members so the clients know whether the client for the newly logged-on member is qualified to be a master. The discovery process can also discover the external IP address of a client and provide that address to the client.

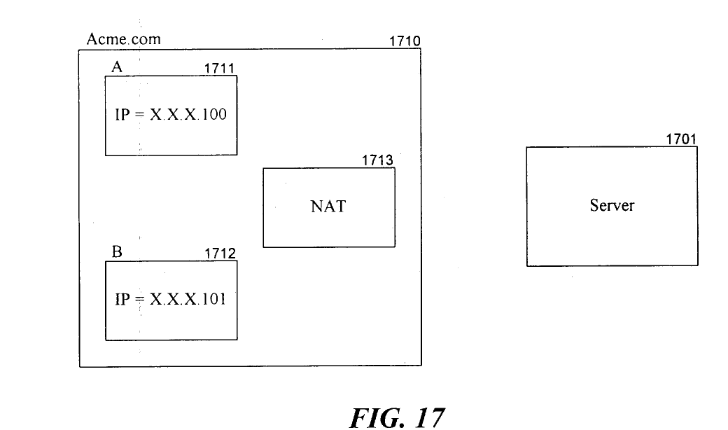

FIG. 17 is a block diagram illustrating the discovery of whether a client is open or closed when the client is attached to the network through a firewall or network address translation router (“NAT”). In this example, the server 1701 communicates with the clients of the Acme.com domain 1710. The clients 1711 and 1712 are attached to the Internet through an NAT router 1713 that allows them to share Acme.com's single Internet connection. From the perspective of the server 1701, clients 1711 and 1712 appear to be coming from the same network address-that of the NAT router 1713. The NAT router 1713 may be configured to forward all external network requests to a single local client. That single client is then open, while the other clients are closed. In FIG. 17, the NAT router 1713 has been configured to forward all external network requests to the client 1711.

Client 1711 initially establishes a session with the server and is assigned a session identifier (“SID”). To discover whether it is open or closed, the client 1711 sends a request message to the server 1701 through the NAT router 1713. The request message includes the SID for client 1711 and the source address of the NAT router 1713. Upon receiving the message, the server tries to connect to the client 1711 using the source address of the NAT router 1713, passing the SID in the message. The NAT router 1713 forwards the message to the client 1711 because of its configuration. The client 1711 compares the SID in the message to its own SID, finding them equal, and replies to the server 1701 with success. The server completes this transaction by replying to the client 1711 with a message that the client is open, along with the external address of the NAT router 1713, which is the effective external address of the client 1711.

Client 1712 initially establishes a session with the server and is assigned an SID. To discover whether it is open or closed, client 1712 sends a request message to the server 1701 through the NAT router 1713. The request message includes the SID for client 1712 and the source address of the NAT router 1713. Upon receiving the message, the server tries to connect to the client 1712 using the source address of the NAT router 1713, passing the SID in the message. The NAT router 1713 forwards the message to the client 1711 because of its configuration. The client 1711 compares the SID in the message to its own SID, finding them unequal, and replies to the server 1701 with access denied. The server completes this transaction by replying to the client 1712 with a message that the client is closed, along with the external address of the NAT router 1713, which is the effective outbound-only external address of the client 1712.

In many cases, the NAT router 1713 will be configured to not forward to any local client. In that case, when the server 1701 tries to connect back to any client, the connection fails at the NAT router 1713, and the server replies to the requesting client that it is closed.

From the foregoing, it will be appreciated that although specific embodiments of the technology have been described herein for purposes of illustration, various modifications may be made without deviating from the spirit and scope of the invention. For example, the content may be stored in a file and include any type of data, such as graphic images, executable programs, word processing programs, etc. When the content represents an image, it may be automatically converted to a JPEG format and to a standard size when it is shared. In addition, the JPEG format may be a progressive format, so that members can view an image in an increasingly higher resolution as the image is being received by the client. Accordingly, the invention is not limited, except by the appended claims.

I/we claim:

1. A content sharing system for sharing content among clients comprising:
a server component at a server that controls logging on of users and distribution of messages sent from one client to another client; and
a client component at each client that elects a qualified client as a master, that shares content by notifying the master of the shared content and providing the shared content to the master, and that, when the client is a master and is notified of shared content, sends a message informing other clients of the shared content so that the other clients can be provided with a copy of the shared content without the shared content being provided to the server.

2. The content sharing system of claim 1 wherein a client component elects a master based on a predefined ordering of the clients.

3. The content sharing system of claim 2 wherein the ordering is based on logon times of users.

4. The content sharing system of claim 2 wherein the ordering is based on names associated with users.

5. The content sharing system of claim 1 wherein a client is qualified when its user is logged-on and it is open to receive communications from all other clients of users that are logged-on.

6. The content sharing system of claim 1 wherein a client provides an HTTP server.

7. The content sharing system of claim 1 wherein the message informing other clients of the shared content includes an indication of how the client is to be provided with the content.

8. The content sharing system of claim 7 wherein portions of the content are provided by different clients.

9. The content sharing system of claim 1 wherein the content is organized into folders.

10. The content sharing system of claim 9 wherein each folder has a master.

11. The content sharing system of claim 9 wherein each folder has members.

12. The content sharing system of claim 1 wherein the clients communicate with the server via a communications protocol and the clients communicate with other clients directly via a different communications protocol.

13. The content sharing system of claim 1 wherein the content is automatically converted to JPEG format when being shared.

14. The content sharing system of claim 13 wherein the JPEG format is a progressive format.

15. The content sharing system of claim 13 wherein the content is automatically converted to a standard size.

16. A method for electing a master for a plurality of systems, the method comprising:
at each of the plurality of systems, selecting a qualified system based on an ordering as the master; and
when a new system that is qualified and has an ordering that is earlier than the ordering of the current master, selecting the new system as the master.

17. The method of claim 16 wherein the ordering is based on logon time.

18. The method of claim 16 wherein the ordering is based on a name.

19. The method of claim 18 wherein when a system logs on, a new master is selected when the newly logged-on system is ordered earlier than the system of the current master.

20. The method of claim 16 wherein the systems share content.

21. The method of claim 20 wherein the master coordinates the distribution of shared content to all systems.

22. The method of claim 16 including electing a local master for the systems of logged-on users.

23. A method in a computer system for designating that an entity is a member of a group of entities, the method comprising:
receiving an indication that the entity is to be a member of the group;
sending an invitation to the entity;
sending to the members of the group a notification that the entity has been invited to be a member of the group; and
when the entity decides whether to accept the invitation, sending by the entity a response to the invitation to all members of the group so that each member knows whether the entity is now a member.

24. The method of claim 23 wherein the notification is also sent to any invited entity that has not yet decided whether to become a member.

25. The method of claim 23 wherein the entities are users.

26. The method of claim 23 wherein the entities share content.

27. The method of claim 23 wherein the computer system is part of a content sharing system.

28. A method of discovering whether a system is closed, the method comprising:
sending from the system to another system a request;
upon receiving the request at the other system, sending from the other system to the system a request; and
when the other system detects that the system cannot respond to the sent request, sending from the other system to the system a response indicating that the system is closed.

29. The method of claim 28 wherein a system is closed when it cannot respond to a request.

30. The method of claim 28 wherein each system implements an HTTP server.

31. The method of claim 28 wherein a request is an HTTP get request message and a response is an HTTP response message.

32. The method of claim 28 including when the other system detects that the system can respond to the request, sending to the system a response indicating that the system is open.

33. A method of discovering whether an originating system is closed, the method comprising:
receiving from a system via a session with a session identifier a message, the message including the session identifier of the originating system; and
when the session identifier of the session and the session identifier of the message do not match, indicating that the originating system is closed.

34. The method of claim 33 wherein the originating system communicates with a server via port forwarding.

35. A method in a computer system for sending data as packets via a communications mechanism that does not guarantee delivery of the packets, the method comprising:
dividing the data into packets with a sequence number;
sending via the communications mechanism each packet twice to a receiver;
receiving from the receiver an indication of which packets the receiver did not receive; and
resending via the communications mechanism each packet that was not received.

36. The method of claim 35 wherein the receiver discards duplicate packets, sends notification to the sender of packets that were not received, and assembles the packets in sequence number order to form the data.

37. The method of claim 35 wherein the communications mechanism is the user datagram protocol.
